(19) United States
(12) Patent Application Publication
(10) Pub. No.: US 2016/0282692 A1
(43) Pub. Date: Sep. 29, 2016

(54) DISPLAY PANEL

(71) Applicant: INNOLUX CORPORATION, MIAO-LI COUNTY (TW)

(72) Inventors: YI-LING YU, MIAO-LI COUNTY (TW); WEI-CHING CHO, MIAO-LI COUNTY (TW); HSIA-CHING CHU, MIAO-LI COUNTY (TW); PENG-CHENG HUANG, MIAO-LI COUNTY (TW)

(21) Appl. No.: 15/072,426

(22) Filed: Mar. 17, 2016

(30) Foreign Application Priority Data
Mar. 24, 2015 (TW) 104109335

(51) Int. Cl. G02F 1/1362; G02F 1/1339; G02F 1/1333

(52) U.S. Cl. CPC G02F 1/136286; G02F 1/13338; G02F 1/13394

(57) ABSTRACT

A display panel includes a first substrate, a second substrate, a scan line, a channel layer, a data line, and a spacer. The scan line is disposed on the first substrate. The channel layer is disposed on the scan line. The data line is disposed on the first substrate and intersects with the scan line, and the data line has at least an overlapping region is superimposed on the scan line. The overlapping region of the data line has a first region disposed on the channel layer, and the first region has a through hole. The spacer is disposed on the data line and has a portion disposed on the first region and another portion disposed on a portion of the overlapping region outside of the first region.

### BACKGROUND

1. Field of the Invention

The instant disclosure relates to a structure of a display panel, in particular, to a display panel having spacers.

2. Description of Related Art

At present, most thin film transistor liquid crystal displays (TFT-LCD) include an active element array substrate, a color filter and a backlight module. The active element array substrate includes a substrate and a plurality of thin film transistors formed on the substrate. The thin film transistors are used to control the voltage of sub-pixel to adjust the deflection angle of the liquid crystal molecule, so that the light amount passing through the polarizer can be controlled. As such, the grey scale of each sub-pixel can be determined by the thin film transistors. By adjusting the gray scale of each sub-pixel and the use of the color filter, a display image can be displayed when the backlight module or self-luminous element emits lights.

As the development of touch technology, the touch technology is widely implemented in most current display panels to replace conventional control devices, such as the mouse and keyboard, to control the cursor and schema. When a user uses a display panel by touching the surface of the display panel, an upper substrate of the display panel will slightly downward deform due to the pressure. In this situation, a portion of spacers arranged between the upper substrate and the lower substrate to separate the upper substrate from the lower substrate may also deform, deviate or slide as the upper substrate is being pressed. However, the deviations of the portion of the spacers may result in abnormal rotations of the liquid crystal molecules and the abnormal display images of the display panel.

### SUMMARY OF THE INVENTION

The embodiment of the instant disclosure provides a display panel having an active element array layer to improve the deviation of spacer caused by pressure.

One of the embodiments of the instant disclosure provides a display panel which includes a first substrate, a second substrate, a scan line, a channel layer, a data line and a spacer. The scan line is disposed on the first substrate. The channel layer is disposed on the scan line. The data line is disposed on the first substrate and intersects with the scan line, and the data line has at least an overlapping region superimposing on the scan line. The overlapping region of the data line has a first region, and the first region is disposed on the channel layer and has a through hole. The spacer is disposed on the data line and has a first portion and a second portion, in which the first portion is disposed on the first region and the second portion is disposed outside of the first region.

Another embodiment of the instant disclosure provides a display panel. The display panel includes a first substrate, a scan line, a channel layer, a data line and a pixel electrode. The scan line disposed on the first substrate has a first side and a second side. The channel layer is disposed on the scan line, and the pixel electrode is disposed on the first substrate. The data line is disposed on the first substrate and intersects with the scan line. The data line has at least an overlapping region superimposing on the scan line. The overlapping region of the data line has a first region, and the first region is disposed on the channel layer and has a through hole. The first region has a fifth side adjacent to the first side and a sixth side adjacent to the second side. A first minimum distance between the first side and the fifth side is larger than a second minimum distance between the second side and the sixth side.

In summary, a display panel is provided in the instant disclosure. The data line has an overlapping region including the first region, the second region and the third region, in which the first region has a higher surface level than that of the second region and that of the third region because the first region is superimposed on the channel layer. Accordingly, the overlapping region has at least one step-difference structure formed between the first region and the second region (or the third region). The display panel further includes the spacer having a first portion disposed on the first region and a second portion disposed outside of the first region, i.e., the spacer is arranged on the data line in alignment with the step-difference structure. As such, when the second substrate of the display panel is deformed downward under a touch pressure provided by the user, the bottom portion of the spacer is forced to engage to the step-difference structure and the sliding friction force is produced and enhanced to resist the sliding movement of the spacer. Accordingly, the abnormal rotations of the liquid crystal molecules due to the deviation of the spacer can be avoided as possible.

In addition, the channel layer can be arranged relatively distant from the pixel electrode electrically connected to the channel layer and closer to another pixel electrode insulated from the channel layer. Additionally, the pixel electrode can be arranged to partially overlap with the channel layer and a first side of the scan line. As such, it is can be avoided that the protruding portion of the pixel electrode partially overlaps with the data line during the processing procedure, and further prevent the formation of the back channel and the parasitic capacitance from increasing.

Furthermore, the scan line can have a first recessed portion, so that the overlapping region has smaller area to reduce the parasitic capacitance between the data line and the scan line. Additionally, the first recessed portion of the scan line has a relatively gentle slope to assist in forming the data line.

In another embodiment, the scan line can further have a second recessed portion, and the second recessed portion and the first recessed portion are respectively formed on opposite two sides of the scan line and both located at a cross portion where the scan line and the data line are crossed such that the formation of the data line on the scan line having the first and second recessed portions becomes easier. In addition, the second region and the third region have smaller areas, which results in lower parasitic capacitance between the data line and the scan line.

In order to further understand the techniques, means and effects of the instant disclosure, the following detailed descriptions and appended drawings are hereby referred to, such that, and through which, the purposes, features and aspects of the instant disclosure can be thoroughly and concretely appreciated; however, the appended drawings are merely provided for reference and illustration, without any intention to be used for limiting the instant disclosure.

### BRIEF DESCRIPTION OF THE DRAWINGS

FIG. 1 illustrates a cross-sectional view of a display panel according to an embodiment of the instant disclosure.

FIG. 2 illustrates a diagrammatic plane view of a first substrate according to an embodiment of the instant disclosure.

FIG. 3 illustrates partial schematic view of an active element array layer according to an embodiment of the instant disclosure.

FIG. 4A illustrates a cross-sectional view along the line M-M′ of FIG. 3.

FIG. 4B illustrates a cross-sectional view showing using the state diagram of FIG. 4A.

FIG. 4C illustrates a cross-sectional view along the line N-N′ of FIG. 3.

FIG. 5 illustrates a diagrammatic plane view of a display panel according to another embodiment of the instant disclosure.

FIG. 6 illustrates a diagrammatic plane view of a display panel according to another embodiment of the instant disclosure.

FIG. 7 illustrates a diagrammatic plane view of a display panel according to another embodiment of the instant disclosure.

### DETAILED DESCRIPTION OF THE PREFERRED EMBODIMENTS

The accompanying drawings show some exemplary embodiments, and a more detailed description of various embodiments with reference to the accompanying drawings in accordance with the present disclosure is set forth below. The concept of the invention may be embodied in many different forms and should not be construed as limited to the embodiment set forth herein. To be more precise, the exemplary embodiments set forth herein are provided to a person of ordinary skill in the art to thoroughly and completely understand the contents disclosed herein and fully provide the spirit of the invention. In each of the drawings, the relative size, proportions, and depiction of the layers and regions in the drawings may be exaggerated for clarity and precision, and in which like numerals indicate like elements.

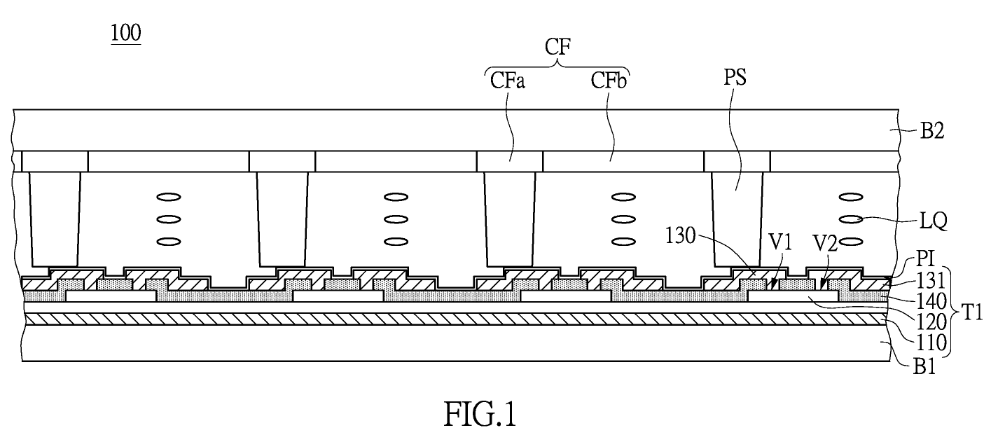

FIG. 1 illustrates a cross-sectional view of a display panel according to an embodiment of the instant disclosure. In instant embodiment, a display panel 100 is a liquid crystal panel. The display panel 100 includes a first substrate B1, a second substrate B2, a color filter layer CF, a liquid crystal layer LQ, an active element array layer T1 and a spacer PS. The first substrate B1 is combined with the second substrate B2, and the liquid crystal layer LQ, the active element array layer T1 and the spacer PS are located between the first substrate B1 and the second substrate B2. In general, the active element array layer T1 is disposed on the first substrate B1 to form an active element array substrate. The color filter layer CF can be disposed on the second substrate B2 and include a light shielding layer CFa and several color filters CFb with various colors. The liquid crystal layer LQ is disposed on an interval between the first substrate B1 and the second substrate B2 to adjust the polarization direction of incident light. In addition, the display panel 100 can further include the alignment film PI. The alignment film PI is approximately located between the liquid crystal layer LQ and the active element array layer T1. In addition, the alignment film PI is located outside of the liquid crystal layer LQ. The active element array layer T1 and the alignment film PI control the rotation of liquid crystal.

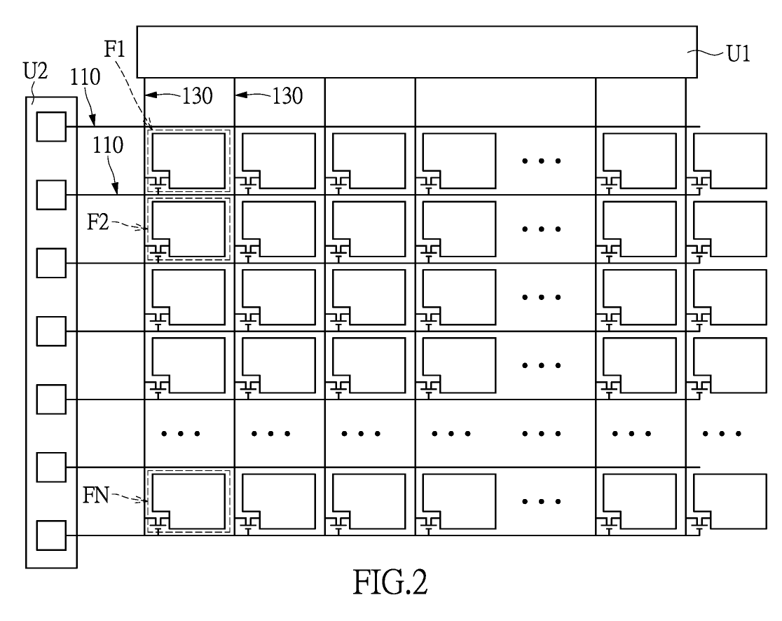

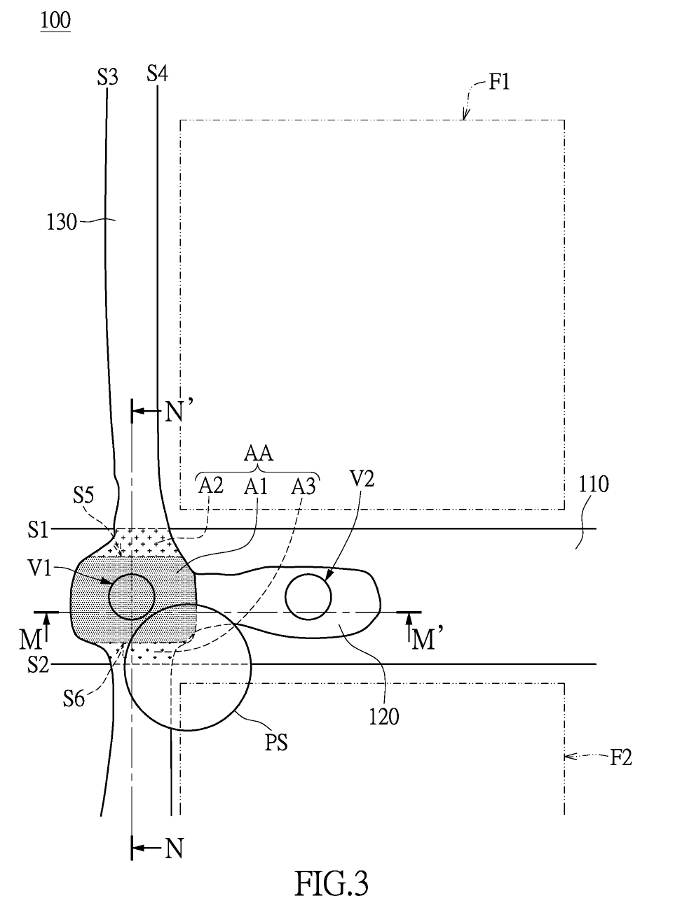

FIG. 2 illustrates a diagrammatic plane view of a first substrate according to an embodiment of the instant disclosure. FIG. 3 illustrates partial schematic view of an active element array layer according to an embodiment of the instant disclosure. Please refer to FIG. 2 and FIG. 3. The data line drive unit U1 is disposed on one side of the active element array substrate T1, and the scan line drive unit U2 is disposed on another side of the active element array substrate T1. In this embodiment, the active element array layer T1 includes the scan line 110, the channel layer 120 and the data line 130. The scan line 110 is disposed on the first substrate B1, and the channel layer 120 is disposed on the scan line 110. The data line 130 is disposed on the first substrate B1 and intersects with the scan line 110. In addition, the data line 130 is located upon the channel layer 120. In practice, several scan lines 110 extend toward the row direction and are parallel with each other, and several data lines 130 extend toward the column direction and are parallel with each other. These scan lines 110 and data lines 130 intersect with each other and are arranged in a stacking manner to define several sub pixel units FN, in which N is larger than 1, such as F1, F2 and so on.

The channel layer 120 is a semiconductor layer whose materials can be selected from a group consisting of polysilicon, metal oxide semiconductor, amorphous silicon, and the combination thereof. In this embodiment, the material of the channel layer 120 can be selected from indium-gallium-zinc oxide, zinc oxide, stannous oxide, indium-zinc oxide, gallium-zinc oxide, zinc-tin oxide, indium-tin oxide or mixtures thereof. In this embodiment, the material of the channel layer 120 is indium-gallium-zinc oxide. However, the instant disclosure does not limit the material of the channel layer 120. Additionally, the channel layer 120 can be fabricated by magnetron sputtering, metal organic chemical-vapor deposition (MOCVD) or pulsed laser deposition (PLD).

The protection layer 140 is disposed on the channel layer 120 and can serve as an etch stop layer (ESL) in order to prevent the channel layer 120 from damage in subsequent processing procedures, which may result in electrical abnormality. The material of the protection layer 140 is silicon oxide (SiOₓ). The protection layer 140 can be patterned through the lithography etching process to form a through hole V1 and a through hole V2. The data line 130 is arranged on the protection layer 140 in a stacking manner and formed in the through hole V1 to connect the channel layer 120 and serve as a source electrode. During the formation of the data line 130 and the source electrode, the drain electrode 131 connected to the channel layer 120 also can be simultaneously formed in an inner wall of the through hole V2 by the same processing procedure. The drain electrode 131 is electrically isolated from the data line 130 and the source electrode.

The spacer PS is located between the data line 130 of the active element array layer T1 and the second substrate B2 to maintain the cell gap between the first substrate B1 and the second substrate B2. In this embodiment, the spacer PS is formed on the color filter layer CF and extends toward the active element array layer T1. Approximately, the spacer PS is located on a portion of the scan line 110 covered by the data line 130 and in contact with the alignment film PI located on the data line 130. In particular, the spacer PS can be designed to have a sphere shape, polygonal column, cone shape, pyramid shape, multi-layer shape or plate. The spacer PS can be made of photoresist materials with transparent or various colors, polymer materials or silicon-oxygen materials, and can be formed through lithography processes, sputtering process, chemical vapor deposition or spray. However, the instant disclosure does not limit the structure and process conditions of the spacer PS.

Specifically, the scan line 110 has a first side S1 and second side S2, and data line 130 has a third side S3 and fourth side S4. When looking toward the first substrate B1 from the spacer PS in plan-view, the data line 130 is disposed on the scan line 110 intersecting with the scan line 110. A part of the data line 130 is superimposed on the channel layer 120 and the scan line 110. Therefore, the data line 130 has at least one overlapping region AA which is superimposed on the scan line 110, and the data line 130 further has a first region A1 superimposed on the channel layer 120. The first region A1 is located substantially within the overlapping region AA. The overlapping region AA has the first side S1, the second side S2, the third side S3 and the fourth side S4. The boundary of the first region A1 has the third side S3, the fourth side S4, a fifth side S5, and a sixth side S6. That is, the third side S3, the fourth side S4, the fifth side S5 and the sixth side S6 are connected with one another to commonly define first region A1. The fifth side S5 is one of the sides of the first region A1 near the first side S1, and the sixth side S6 is one of the sides of the overlapping region AA near the second side S2. In practice, the fifth side S5 and the sixth side S6 are both parallel to an extension direction of the scan line 110.

When looking toward the first substrate S1 from the spacer PS in plan-view, the other part of the data line 130 is located on the scan line 110 without overlapping with the channel layer 120. Therefore, the another regions of the overlapping region AA located outside of the first region A1 further includes the second region A2 and the third region A3. The boundary of the second region A2 includes the first side S1, the third side S3, the fourth side S4 and the fifth side S4. The boundary of the third area A3 includes the second side S2, the third side S3, the fourth side S4 and the sixth side S6. The spacer PS has a first portion disposed on the first region A1, and a second portion disposed outside of the first region A1, such as on the second region A2 or the third region A3. Additionally, as illustrated in the FIG. 3, the spacer PS further has another portion disposed outside of the data line 130 and the scan line 110.

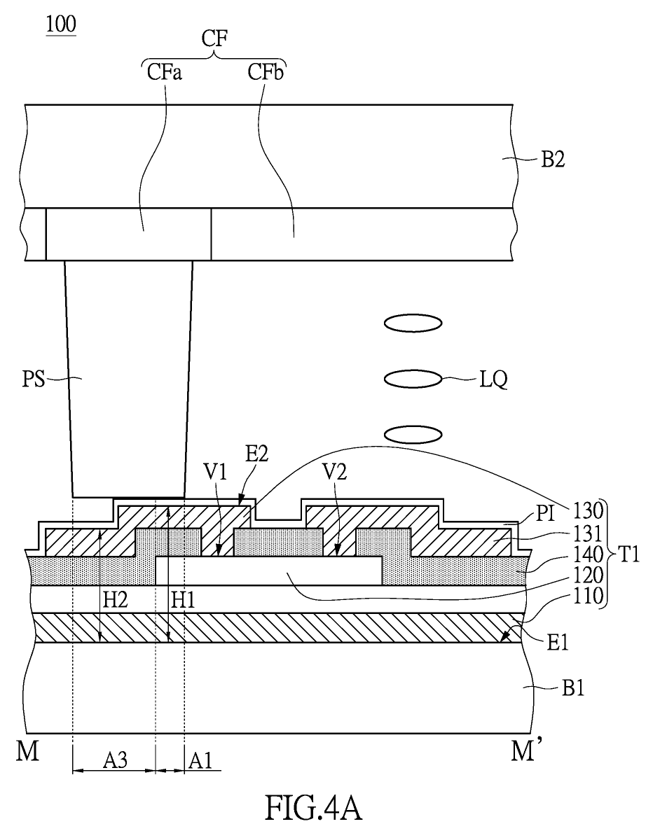

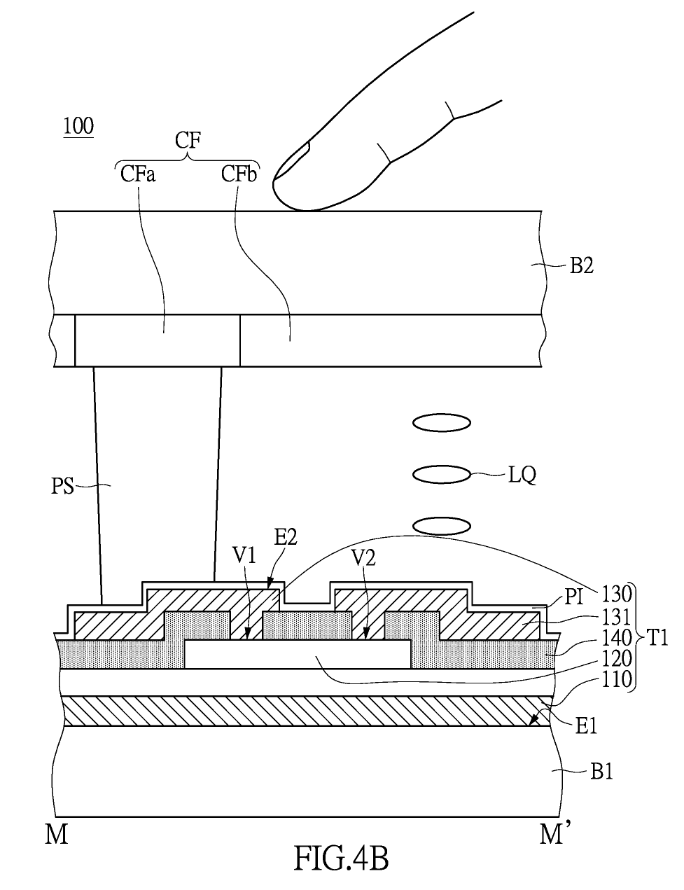

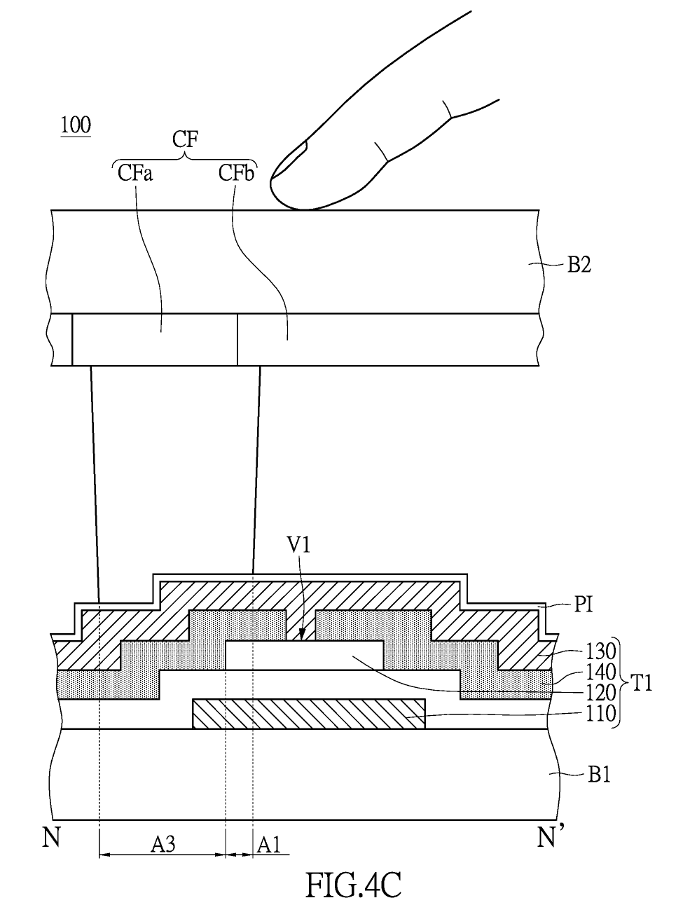

FIG. 4A illustrates a cross-sectional view along the line M-M′ of FIG. 3. FIG. 4B illustrates a cross-sectional view showing using a state diagram of FIG. 4A. FIG. 4C illustrates a cross-sectional view along the line N-N′ of FIG. 3. Please refer to FIG. 4A and 4C accompanied with FIG. 3. In this embodiment, the spacer PS partially corresponds to the first region A1 and partially corresponds to the third region A3. Furthermore, the data line 130 of the first region A1 is stacked on the channel layer 120 and the scan line 110, and the first portion of the spacer PS is disposed on the data line 130, the channel layer 120 and the scan line 110. Additionally, there is a first vertical distance H1 between a part of the second surface E2 in the first region A1 and a first surface E1 of the first substrate B1. The data line 130 of the third region A3 is stacked on the scan line 110 without stacking on the channel layer 120. Furthermore, the spacer PS has the second portion disposed on the portions of the data line 130 and scan line 110 without overlapping with the channel layer 120. There is a second vertical distance H2 between another part of the second surface E2 of the data line 130 in the third region A3 and the first surface E1 of the first substrate B1. Because in the first region A1, there is arranged the channel layer 120, the vertical distances in different regions between the second surface E2 of the data line 130 and the first surface E1 of the first substrate B1 are different, and the first vertical distance H1 is larger than the second vertical distance H2. Therefore, the active element array layer T1 has a step-difference structure formed due to a height difference. As shown in FIG. 4B and 4C, when the user touches the second substrate B2 of the display panel 100, the second substrate B2 will be slightly downward deform due to the touch pressure, which forces the spacer PS to abut the active element array layer T1 (or the alignment film PI). Because a portion of the spacer PS is disposed on the first region A1 and another portion of the spacer PS is disposed on the third area A3, such that the spacer PS correspondingly abuts the step-difference structure of the active element array layer T1 which has the first vertical distance H1 and the second vertical distance H2. Accordingly, since the first portion of the spacer PS is disposed on the first region A1 and the second portion of the spacer PS is disposed on the second region A2 or the third region A3, the friction force can be enhanced due to the step-difference structure of the active element array layer T1 under an external force, so as to reduce the probability of the deviation of the spacer PS and the abnormal rotation of the liquid crystal molecules caused by the deviation of the spacer PS.

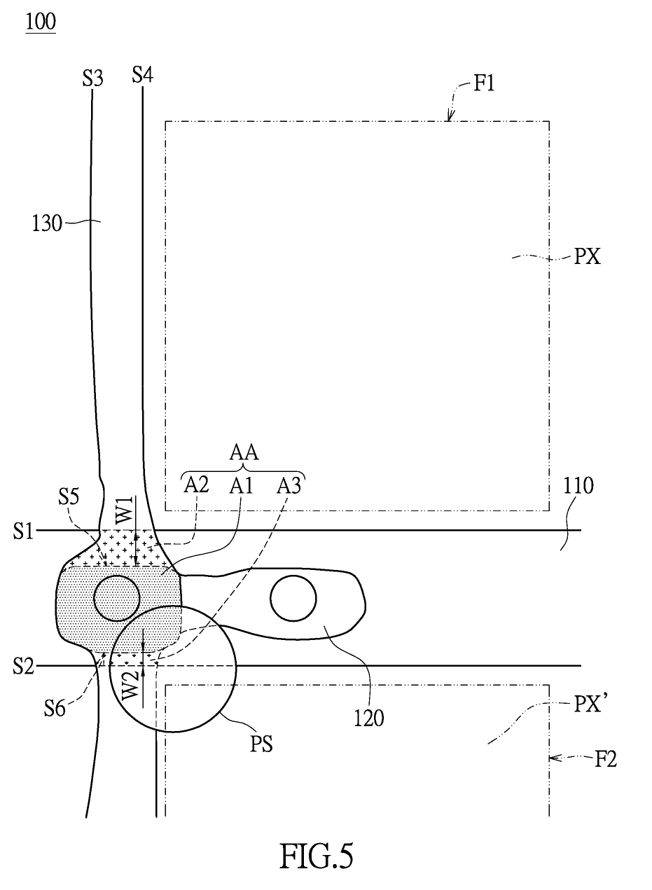

FIG. 5 illustrates a diagrammatic plane view of a display panel according to another embodiment of the instant disclosure. The first minimum distance W1 between the first side S1 and the fifth side S5 is larger than the second minimum distance W2 between the second side S2 and the sixth side S6. When looking toward the first substrate B1 from the spacer PS in plan-view, the location of the channel layer 120 is closer to the next sub pixel unit F2 than the sub pixel unit F1, which are defined by the scan line 110 and the data line 130. In order words, the channel layer 120 is located far away from the pixel electrode PX, to which the channel layer 120 is electrically connected, and closer to the pixel electrode PX′, from which the channel layer is insulated.

Since the spacer PS is partially superimposed on the first region A1 and the third area A3, the bottom portion of the spacer PS can engage with the step-difference structure of the active element array layer T1 to prevent from the deviation thereof under an external force.

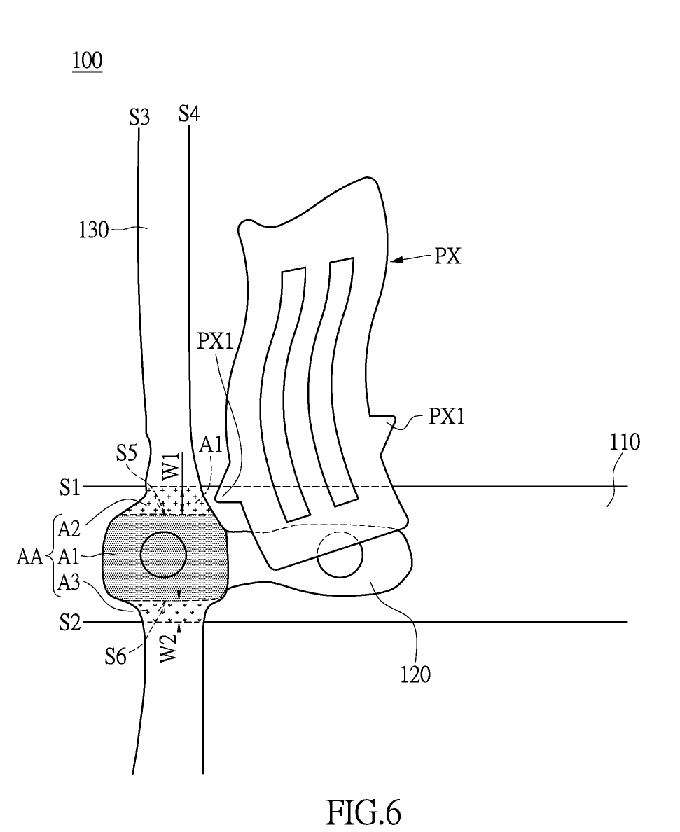

FIG. 6 illustrates a diagrammatic plane view of a display panel according to another embodiment of the instant disclosure. Please refer to FIG. 6. Practically, in view of design of the process parameter or the alignment conditions of liquid crystal, the shape of the pixel electrode PX can be designed to have at least one protruding portion PX1. In one embodiment, preferably, under the condition that the first minimum distance W1 is larger than the second minimum distance W2. In addition, the pixel electrode PX can be arranged to partially overlap with the channel layer 120 and the first side S1 of the scan line 110. In addition, the protruding portion PX1 of the pixel electrode PX may shift and overlap with the data line 130 during the processing procedure, which may result in the formation of the back channel or the parasitic capacitance. By making the pixel electrode PX partially overlap with the channel layer 120 and the first side S1, the formation of the back channel or the parasitic capacitance can be avoided.

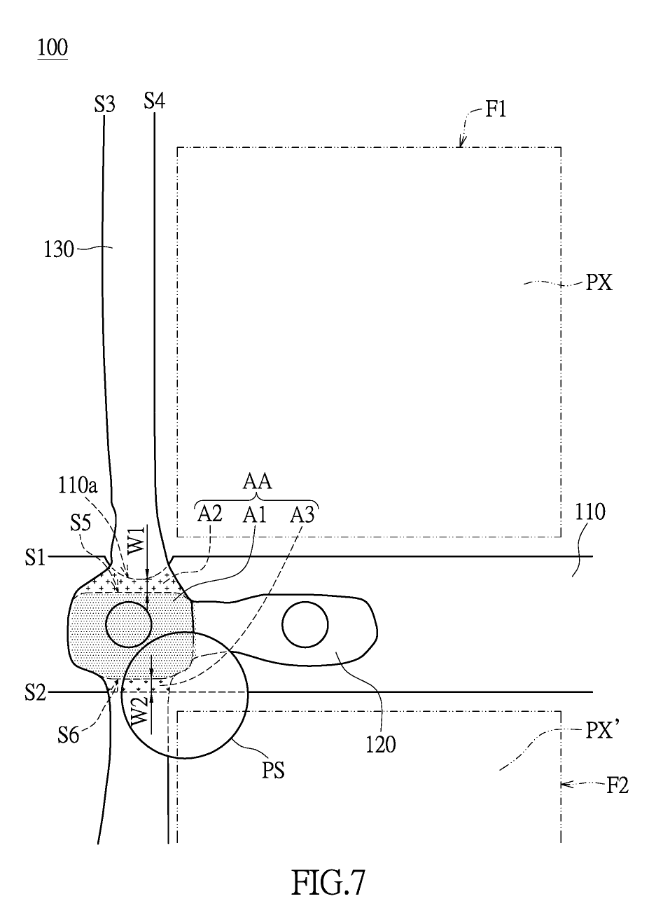

FIG. 7 illustrates a diagrammatic plane view of a display panel according to another embodiment of the instant disclosure. In one embodiment, the scan line 110 substantially extends along the row direction and has a first recessed portion 110a. The first recessed portion 110a is located at a cross portion where the scan line 110 and the data line 130 are crossed. In this embodiment, the first recessed portion 110a is located at the first side S1 of the scan line 110. The data line 130 is arranged on the channel layer 120 and the scan line 110 in a stacking manner, and the data line 130 overlaps with the first recessed portion 110a. Therefore, the area of the overlapping region between the data line 130 and the scan line 110 can be decreased due to the first recessed portion 110a. That is to say, the area of the second region A2 can be decreased due to the first recessed portion 110a. As such, the parasitic capacitance formed between the data line 130 and the scan line 110 can be reduced. In addition, the first recessed portion 110a of the scan line 110 has a relatively gentle slope to assist in forming the data line 130 and to prevent the data line 130 from being broken during the fabricating process. The scan line 110, in another embodiment, further has a second recessed portion (not shown in the figure), and the second recessed portion and the first recessed portion 110a are respectively formed on opposite two sides of the scan line 110 and both located at a cross portion where the scan line 110 and the data line 130 are crossed such that the formation of the data line 130 on the scan line 110 having the first and second recessed portions becomes easier. In addition, the second region A2 and the third region A3 have smaller areas, which results in lower parasitic capacitance between the data line 130 and the scan line 110.

In summary, a display panel is provided in the instant disclosure. The data line has an overlapping region including the first region, the second region and the third region, in which the first region has a higher surface level than that of the second region and that of the third region because the first region is superimposed on the channel layer. Accordingly, the overlapping region has at least one step-difference structure formed between the first region and the second region (or the third region). The display panel further includes the spacer having a first portion disposed on the first region and a second portion disposed on one of the second region or the third region, i.e., the spacer is arranged on the data line in alignment with the step-difference structure. As such, when the second substrate of the display panel is deformed downward under a touch pressure provided by the user, the bottom portion of the spacer is forced to engage to the step-difference structure and the sliding friction force is produced and enhanced to resist the sliding movement of the spacer. Accordingly, the abnormal rotations of the liquid crystal molecules due to the deviation of the spacer can be avoided as possible.

In addition, the channel layer can be arranged relatively distant from the pixel electrode electrically connected to the channel layer and closer to another pixel electrode insulated from the channel layer. Additionally, the pixel electrode can be arranged to partially overlap with the channel layer and a first side of the scan line. As such, it is can be avoided that the protruding portion of the pixel electrode partially overlaps with the data line during the processing procedure, and further prevent the formation of the back channel and the parasitic capacitance from increasing.

Furthermore, the scan line can have a first recessed portion, so that the overlapping region has smaller area to reduce the parasitic capacitance between the data line and the scan line. Additionally, the first recessed portion of the scan line has a relatively gentle slope to assist in forming the data line 130.

In another embodiment, the scan line can further have a second recessed portion, and the second recessed portion and the first recessed portion are respectively formed on opposite two sides of the scan line and both located at a portion of the scan line covered by the data line such that the formation of the data line on the scan line having the first and second recessed portions becomes easier. In addition, the second region and the third region have smaller areas, which results in lower parasitic capacitance between the data line 130 and the scan line.

In order to further understand the techniques, means and effects of the instant disclosure, the following detailed descriptions and appended drawings are hereby referred to, such that, and through which, the purposes, features and aspects of the instant disclosure can be thoroughly and concretely appreciated; however, the appended drawings are merely provided for reference and illustration, without any intention to be used for limiting the instant disclosure.

What is claimed is:

1. A display panel, comprising:
a first substrate;
a scan line disposed on the first substrate;
a channel layer disposed on the scan line;
a data line disposed on the first substrate and intersecting with the scan line, wherein the data line has at least an overlapping region superimposed on the scan line, the overlapping region of the data line has a first region disposed on the channel layer; and
a spacer disposed on the data line, wherein the spacer has a first portion and a second portion, the first portion is disposed on the first region, and the second portion is disposed outside of the first region.

2. The display panel according to claim 1, wherein the overlapping region further includes a second region and a third region, the scan line has a first side and a second side, the data line has a third side and a fourth side, the first region has a fifth side adjacent to the first side and a sixth side adjacent to the second side, a boundary of the second region includes the fifth side, the first side, the third side and the fourth side, and a boundary of the third area includes the sixth side, the second side, the third side and the fourth side.

3. The display panel according to the claim 2, wherein the fifth side and the sixth side of the first region are both substantially parallel to an extension direction of the scan line.

4. The display panel according to the claim 2, wherein a first minimum distance between the first side and the fifth side is larger than a second minimum distance between the second side and the sixth side.

5. The display panel according to the claim 4, wherein the second portion is disposed on the third region.

6. The display panel according to the claim 5, wherein the first substrate has a first surface and the data line has a second surface, and a first vertical distance between the first surface and a part of the second surface is larger than a second vertical distance between the first surface and another part of the second surface.

7. The display panel according to the claim 4, wherein the display panel further comprises a pixel electrode covering the first side.

8. The display panel according to the claim 1, wherein the scan line has a first recessed portion, and the data line is superimposed on the first recessed portion.

9. The display panel according to the claim 8, wherein the scan line further has a second recessed portion, and the second recessed portion and the first recessed portion are respectively formed at opposite two sides of the scan line.

10. The display panel according to the claim 1, wherein the channel layer comprises metal oxide.

11. A display panel, comprising:
a first substrate;
a scan line disposed on the first substrate, wherein the scan line has a first side and a second side;
a channel layer disposed on the scan line;
a pixel electrode disposed on the first substrate; and
a data line disposed on the first substrate and intersecting with the scan line, wherein the data line has at least an overlapping region superimposed on the scan line, and the overlapping region of the data line has a first region disposed on the channel layer,
wherein the first region has a fifth side adjacent to the first side and a sixth side adjacent to the second side, and a first minimum distance between the first side and the fifth side is larger than a second minimum distance between the second side and the sixth side.

12. The display panel according to the claim 11, wherein the display panel further comprises a spacer having a first portion disposed on the first region.

13. The display panel according to the claim 12, wherein the spacer has a second portion disposed outside of the first region.

14. The display panel according to the claim 13, wherein the overlapping region further includes a second region and a third region, the data line has a third side and a fourth side, the second region has a boundary including the fifth side, the first side, the third side and the fourth side, the third area has a boundary including the sixth side, the second side, the third side and the fourth side, and the second portion of the spacer is disposed on the second region.

15. The display panel according to claim 14, wherein the first substrate has a first surface and the data line has a second surface, and the spacer is disposed on the first region and the third region, and a first vertical distance between a part of the second surface in the first region and the first surface is larger than a second vertical distance between another part of the second surface in the second region and the first surface.

16. The display panel according to claim 11, wherein the fifth side and the sixth side of the first region are both substantially parallel to an extension direction of the scan line.

17. The display panel according to claim 11, wherein the scan line has a first recessed portion, and the data line overlaps with the first recessed portion.

18. The display panel according to the claim 17, wherein the scan line further includes a second recessed portion, and the second recessed portion and the first recessed portion are respectively formed at opposite two sides of the scan line.

19. The display panel according to the claim 11, wherein the channel layer comprises metal oxide.
